(19) United States
(12) Patent Application Publication
(10) Pub. No.: US 2019/0278154 A1
(43) Pub. Date: Sep. 12, 2019

(54) LIQUID CRYSTAL LENS

(71) Applicant: Theia Limited, Hsinchu County (TW)

(72) Inventors: Yu-Hsuan Lin, Hsinchu County (TW); Chung-Yi Wang, Hsinchu County (TW)

(73) Assignee: Theia Limited, Hsinchu County (TW)

(21) Appl. No.: 16/296,413

(22) Filed: Mar. 8, 2019

Related U.S. Application Data
(60) Provisional application No. 62/641,459, filed on Mar. 12, 2018.

(51) Int. Cl. G02F 1/29; G06F 3/044

(52) U.S. Cl. CPC G02F 1/29; G06F 2203/04104; G02F 2001/294; G06F 3/044

(57) ABSTRACT

A liquid crystal lens is provided. The liquid crystal lens includes an electrode group, a touch panel and a liquid crystal layer. The electrode group includes a left electrode, a right electrode and an intermediate electrode, wherein the intermediate electrode is located between the left electrode and the right electrode. The touch panel is disposed above the electrode group. The liquid crystal layer is disposed between the touch panel and the electrode group. A voltage value of the touch panel is the same as a voltage value of the intermediate electrode, a voltage value of the left electrode is to the same as a voltage value of the right electrode. When the voltage value of the touch panel is V_{T}*sin(wt), the voltage value of the left electrode is V_{L}*sin(wt)+ V_{T}*sin(wt).

### BACKGROUND OF THE INVENTION

### Field of the Disclosure

The present disclosure relates to a liquid crystal lens, and more particularly to a liquid crystal lens with a touch panel.

### Description of Related Art

Please refer to FIG. 1. FIG. 1 is a schematic diagram of a conventional liquid crystal lens 10. The liquid crystal lens 10 is a lens capable of adjusting a focal length. The liquid crystal lens 10 includes an ITO coated plate 12, an intermediate liquid crystal layer 13, two side electrodes 14, an intermediate electrode 15, and two high-resistance transparent conductive films 16, wherein the two side electrodes 14, the intermediate electrode 15, and the two transparent conductive films 16 are connected in series. Through the voltage control of the electrodes, the two high-resistance transparent conductive films 16 and the upper ITO coated plate 12, the power line distribution can be arranged, such that liquid crystal molecules 130 of the liquid crystal layer 13 are driven to be deflected by the electric field, and are arranged to have an effect similar to an optical lens. (Please refer to FIG. 2. FIG. 2 is a schematic diagram showing deflection of liquid crystal molecules 130.) As a result, when light passes through the structure of the liquid crystal lens 10, the light is affected by the arrangement of the liquid crystal molecules 130, thereby producing an optical effect causing the light either to converge or diverge. However, the conventional liquid crystal lens 10 does not have a touch function.

Hence, how to design a liquid crystal lens with touch function is worthy of consideration by those who have ordinary knowledge in the field.

### SUMMARY OF THE INVENTION

In order to solve the above problems, it is an object of the present invention to provide a liquid crystal lens.

According to an exemplary embodiment, a liquid crystal lens is provided. The liquid crystal lens comprises an electrode group, a touch panel and a liquid crystal layer. The electrode group comprises a left electrode, a right electrode and an intermediate electrode, wherein the intermediate electrode is located between the left electrode and the right electrode. The touch panel is disposed above the electrode group. The liquid crystal layer is disposed between the touch panel and the electrode group. Wherein a voltage value of the touch panel is the same as a voltage value of the intermediate electrode, a voltage value of the left electrode is the same as a voltage value of the right electrode and when the voltage value of the touch panel is V_{T}*sin(wt), the voltage value of the left electrode is V_{L}*sin(wt)+ V_{T}*sin(wt).

In the above liquid crystal lens, V_{L}*sin(wt) is 3˜10 volts, and V_{T}*sin(wt) is 2˜5 volts.

In the above liquid crystal lens, the electrode group further comprises a first transparent conductive film and a second transparent conductive film, wherein the first transparent conductive film is connected in series between the left electrode and the intermediate electrode and the second transparent conductive film is connected in series between the right electrode and the intermediate electrode.

According to another exemplary embodiment, another liquid crystal lens is provided. The liquid crystal lens comprises an electrode group, a touch panel and a liquid crystal layer. The electrode group comprises a left electrode, a right electrode and an intermediate electrode, wherein the intermediate electrode is located between the left electrode and the right electrode. The touch panel is disposed above the electrode group. The liquid crystal layer is disposed between the touch panel and the electrode group. Wherein a fundamental frequency of the touch panel is 100 times a fundamental frequency of the liquid crystal layer.

In the above liquid crystal lens, the fundamental frequency of the liquid crystal layer is 60 Hz to 1 kHz.

In the above liquid crystal lens, a voltage value of the intermediate electrode is 0 volts.

In the above liquid crystal lens, a voltage value of the touch panel is V_{T}*sin(wt), a voltage value of the left electrode and a voltage value of the right electrode are both V_{L}*sin(wt), V_{T}*sin(wt) is 2˜5 volts, and V_{L}*sin(wt) is 3˜10 volts.

In the above liquid crystal lens, the electrode group further comprises a first transparent conductive film and a second transparent conductive film, wherein the first transparent conductive film is connected in series between the left electrode and the intermediate electrode and the second transparent conductive film is connected in series between the right electrode and the intermediate electrode.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a conventional liquid crystal lens.

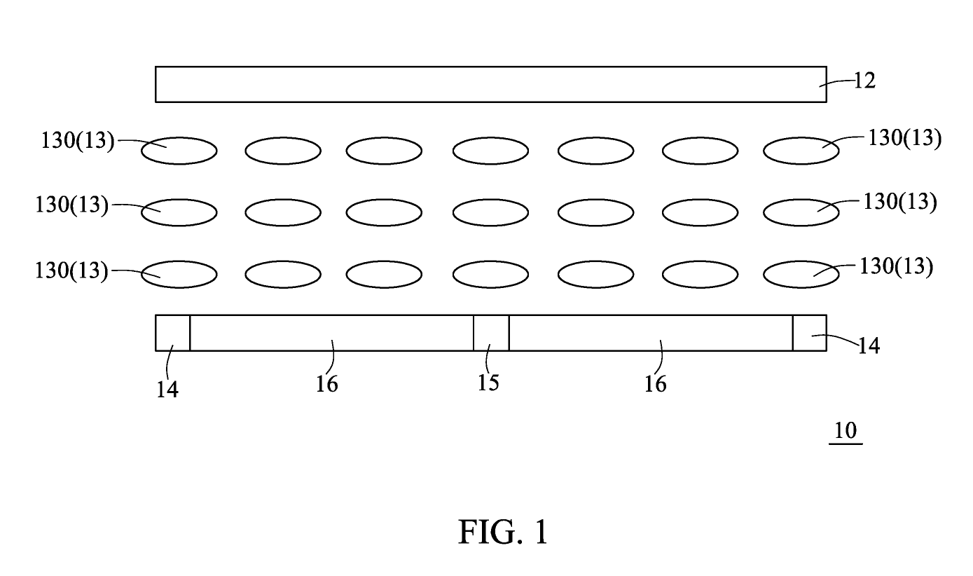

FIG. 2 is a schematic diagram showing deflection of liquid crystal molecules.

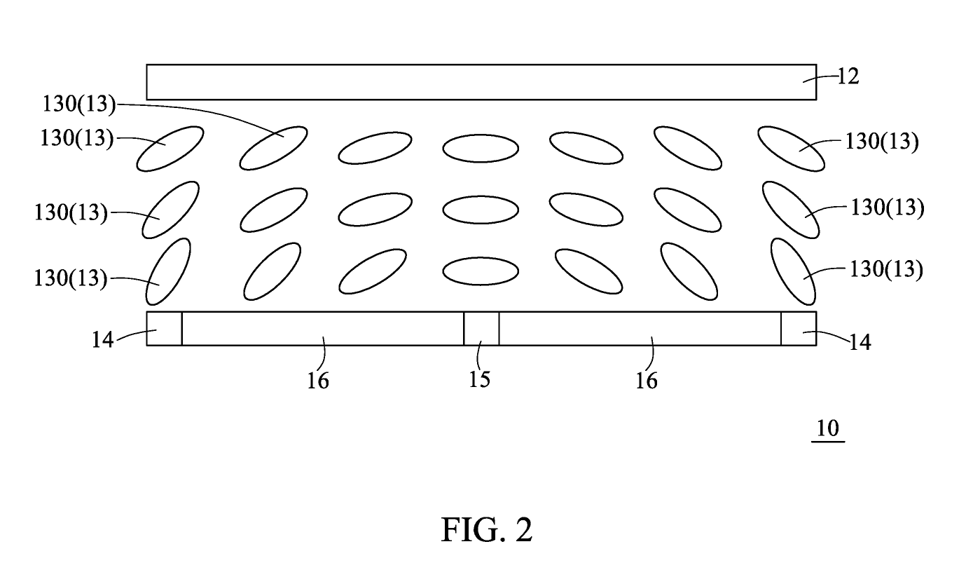

FIG. 3A is a schematic diagram of a liquid crystal lens according to an embodiment of the present invention.

FIG. 3B is a top view of a touch panel.

FIG. 4 is a schematic diagram showing deflection of liquid crystal molecules.

### DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

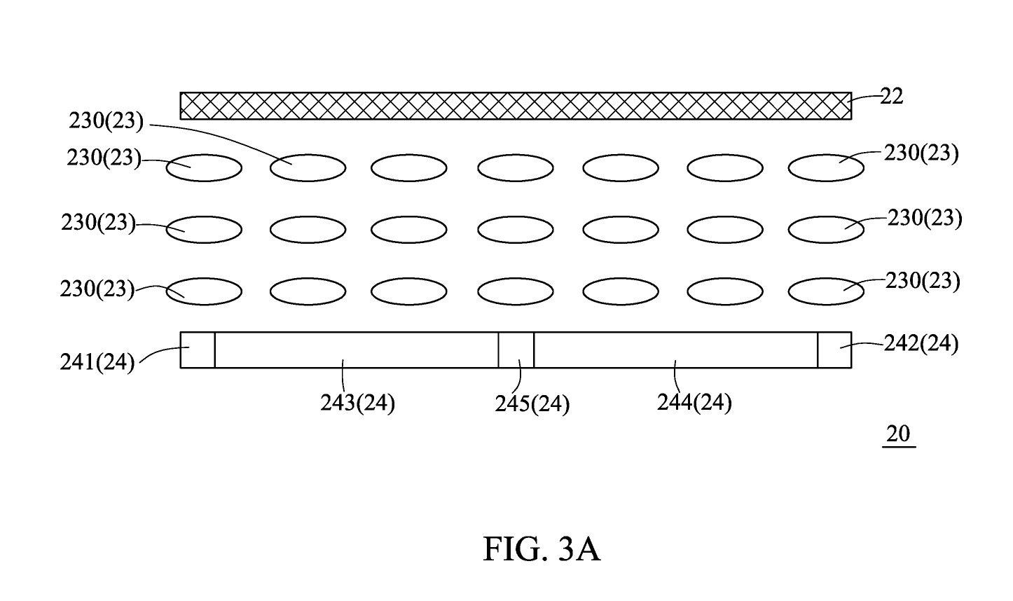

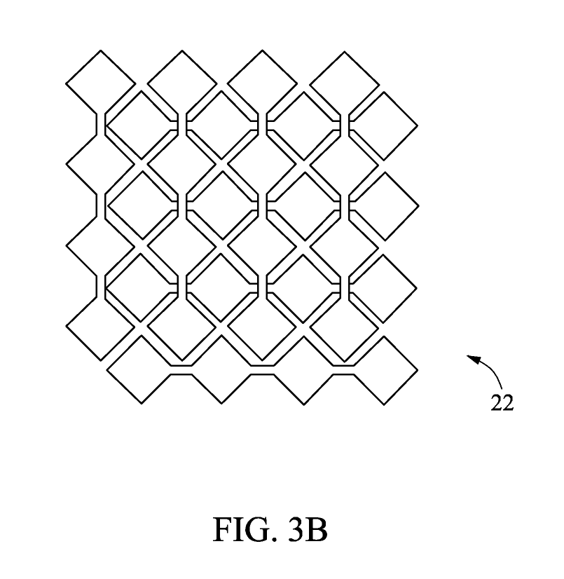

Please refer to FIG. 3A and FIG. 3B. FIG. 3A is a schematic diagram of a liquid crystal lens 20 according to an embodiment of the present invention. FIG. 3B is a top view of a touch panel 22. The liquid crystal lens 20 includes an electrode group 24, a touch panel 22 and a liquid crystal layer 23. The electrode group 24 includes a left electrode 241, a right electrode 242, a first transparent conductive film 243, a second transparent conductive film 244 and an intermediate electrode 245, wherein the intermediate electrode 245 is located between the left electrode 241 and the right electrode 242, the first transparent conductive film 243 is connected in series between the left electrode 241 and the intermediate electrode 245, and the second transparent conductive film 244 is connected in series between the right electrode 242 and the intermediate electrode 245. The touch panel 22 is disposed above the electrode group 24. In this embodiment, the touch panel 22 is a single-layer multi-point touch array, which is transparent, so that the touch panel 22 can also achieve a light transmissive effect. In addition, the liquid crystal layer 23 is disposed between the touch panel 22 and the electrode group 24, and the liquid crystal layer 23 includes a plurality of liquid crystal molecules 230.

A voltage value of the touch panel 22 is the same as a voltage value of the intermediate electrode 245, and a voltage value of the left electrode 241 is the same as a voltage value of the right electrode 242. In detail, when the voltage value of the touch panel 22 is V_{T}*sin(wt), the voltage value of the left electrode 241 and the voltage value of the right electrode 242 must be V_{L}*sin(wt)+ V_{T}*sin(wt). For example, V_{L}*sin(wt) is 3˜10 volts, and V_{T}*sin(wt) is 2˜5 volts. In this way, the liquid crystal molecules 230 feel that the voltage difference between the voltage value of the upper touch panel 22 and the voltage value of the left electrode 241/the right electrode 242 is merely V_{L}*sin(wt), that is, there is no voltage difference of V_{T}*sin(wt) existed between their voltage values.

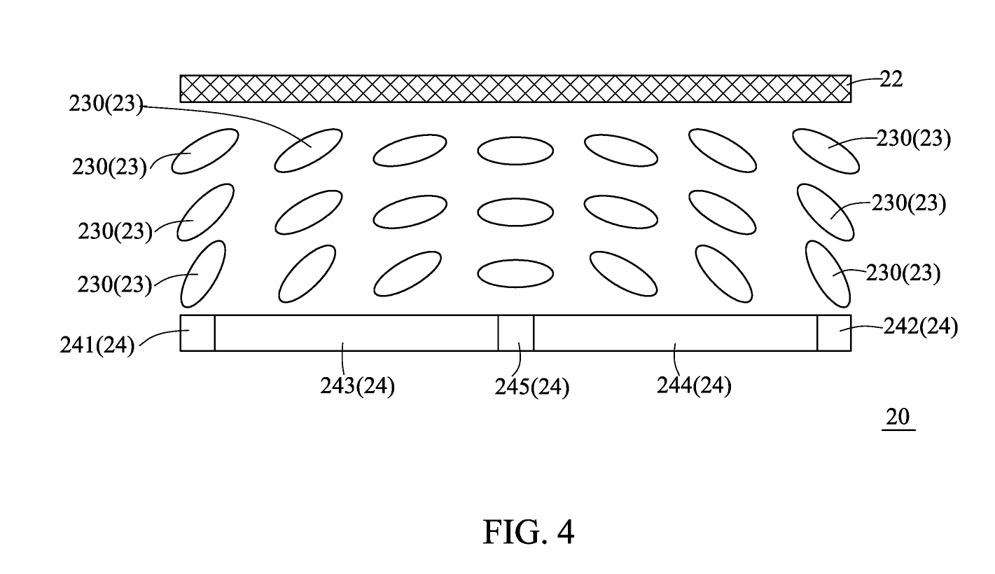

Furthermore, the touch panel 22 can also generate a voltage division by different voltages of the left electrode 241 and the intermediate electrode 245 and different voltages of the right electrode 242 and the intermediate 245, so that the electrode group 24 can generate a continuous voltage distribution. Moreover, since the voltage values of the touch panel 22 and the intermediate electrode 245 are both V_{T}*sin(wt), the electrode group 24 can spread the electric field variation in all regions of the liquid crystal layer 23, and thus not only partial region of the electrode group 24 has the electric field variation. Therefore, the liquid crystal molecules 230 of the liquid crystal layer 23 are driven to be deflected by the electric field variation, and are arranged to have an effect similar to an optical lens. (Please refer to FIG. 4. FIG. 4 is a schematic diagram showing deflection of the liquid crystal molecules 230.) In comparison with the conventional liquid crystal lens 10, the liquid crystal lens 20 in this embodiment further has a touchable system structure in addition to the original function of the lens. This is because an AC signal is generated on the touch panel 22, and the position where the touch panel 22 is touched can be known after the touch panel 22 is touched.

As mentioned above, the current received by the left electrode 241 and the right electrode 242 must be alternating current to avoid the problem of polarization of the liquid crystal molecules 230. Moreover, since the touch panel 22 is transparent, it can achieve a light transmissive effect, such that the liquid crystal lens 20 in this embodiment can directly cover other display screens.

For the liquid crystal lens 20 in this embodiment, when the fundamental frequency of the liquid crystal layer 23 and the fundamental frequency of the touch panel 22 are greatly different (generally, the fundamental frequency of the liquid crystal layer 23 is much lower than the fundamental frequency of the touch panel 22, and the fundamental frequency of the liquid crystal layer 23 is, for example, 60 Hz to 1 kHz), the voltage values of the left electrode 241, the right electrode 242 and the intermediate electrode 245 can be adjusted to facilitate the circuit design of the liquid crystal lens 20. The details are as below:

When the fundamental frequency of the touch panel 22 is 100 times the fundamental frequency of the liquid crystal layer 23, the voltage value of the touch panel 22 can be set to V_{T}*sin(wt), the voltage value of the left electrode 241 and the voltage value of the right electrode 242 can be set to V_{L}*sin(wt), and the voltage value of the intermediate electrode 245 can be set to 0 voltages, wherein V_{T}*sin(wt) is 2˜5 volts and V_{L}*sin(wt) is 3˜10 volts. For example, the fundamental frequency of the liquid crystal layer 23 is 1 k Hz, and the fundamental frequency of the touch panel 22 is 100 k Hz. In this way, since the fundamental frequency of the liquid crystal layer 23 is merely 1 k Hz, the high-frequency touch driving signal formed by the touch panel 22 is invisible to the liquid crystal layer 23. Therefore, the liquid crystal molecules 230 will maintain original deflection characteristics, such that the liquid crystal lens 20 retains the original lens function. Further, since the voltage values of the respective electrodes of the electrode group 24 are more easily set, the whole circuit design of the liquid crystal lens 20 can be simpler, which is beneficial to reduce the production cost.

In summary, the liquid crystal lens 20 in this embodiment has a touch function, and the touch function does not affect the original lens function of the liquid crystal lens 20.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A liquid crystal lens, comprising:
an electrode group, comprising a left electrode, a right electrode and an intermediate electrode, wherein the intermediate electrode is located between the left electrode and the right electrode;
a touch panel, disposed above the electrode group; and
a liquid crystal layer, disposed between the touch panel and the electrode group;
wherein a voltage value of the touch panel is the same as a voltage value of the intermediate electrode, a voltage value of the left electrode is the same as a voltage value of the right electrode; and
wherein when the voltage value of the touch panel is V_{T}*sin(wt), the voltage value of the left electrode is V_{L}*sin(wt)+ V_{T}*sin(wt).

2. The liquid crystal lens in claim 1, wherein V_{L}*sin(wt) is 3˜10 volts, and V_{T}*sin(wt) is 2˜5 volts.

3. The liquid crystal lens in claim 1, wherein the electrode group further comprises:
a first transparent conductive film, wherein the first transparent conductive film is connected in series between the left electrode and the intermediate electrode; and
a second transparent conductive film, wherein the second transparent conductive film is connected in series between the right electrode and the intermediate electrode.

4. A liquid crystal lens, comprising:
an electrode group, comprising a left electrode, a right electrode and an intermediate electrode, wherein the intermediate electrode is located between the left electrode and the right electrode;
a touch panel, disposed above the electrode group; and
a liquid crystal layer, disposed between the touch panel and the electrode group;
wherein a fundamental frequency of the touch panel is 100 times a fundamental frequency of the liquid crystal layer.

5. The liquid crystal lens in claim 4, wherein the fundamental frequency of the liquid crystal layer is 60 Hz to 1 kHz.

6. The liquid crystal lens in claim 4, wherein a voltage value of the intermediate electrode is 0 volts.

7. The liquid crystal lens in claim 6, wherein a voltage value of the touch panel is V_{T}*sin(wt), a voltage value of the left electrode and a voltage value of the right electrode are both V_{L}*sin(wt), V_{T}*sin(wt) is 2˜5 volts, and V_{L}*sin(wt) is 3˜10 volts.

8. The liquid crystal lens in claim 4, wherein the electrode group further comprises:
a first transparent conductive film, wherein the first transparent conductive film is connected in series between the left electrode and the intermediate electrode; and
a second transparent conductive film, wherein the second transparent conductive film is connected in series between the right electrode and the intermediate electrode.
